(19) United States
(12) Patent Application Publication
(10) Pub. No.: US 2002/0190951 A1
(43) Pub. Date: Dec. 19, 2002

(54) Computer mouse with ventilation

(76) Inventor: Sang H. Joo, Monterey Park, CA (US)

Correspondence Address: JAMES E. BAME, PARK & SUTTON LLP, SUITE 1110, 3255 WILSHIRE BLVD, LOS ANGELES, CA, 90010, US

(21) Appl. No.: 09/883,669

(22) Filed: Jun. 19, 2001

(51) Int. Cl. G09G 5/08

(52) U.S. Cl. 345/163

(57) ABSTRACT

A computer mouse with ventilation includes a base having a first air intake inlet, a left side and a right side. The base forms an interior chamber. A cover is mounted on the base. The cover has a first exhaust outlet and an upper surface. A fan is contained within the interior chamber that draws air through the first air intake inlet and expels air out the first exhaust outlet onto the hand of the user.

### BACKGROUND

The present invention relates to a computer mouse. More particularly the present invention pertains to a computer mouse with features to reduce hand perspiration.

Typically, a computer mouse has a substantially solid housing. The hand of the computer user can remain in contact with the computer mouse for long periods of time during operation of the computer. Perspiration can develop on the palm of the hand, which causes slipping of the hand from the mouse. Slippage can interfere with the smooth movements of the computer mouse that controls operations of the computer screen. Perspiration can also be an annoying discomfort to the user.

Present methods of removing perspiration from the hand include wiping the hand with a towel and waving the hand in the air to create rapid air circulation. Both of these methods distract the user from operation of the computer, thus reducing work efficiency.

Therefore, there is a need for a computer mouse with ventilation that will reduce the perspiration on the hand of the user. The ventilation should be created so that there is no increase in the size of the computer mouse housing.

### SUMMARY

An objective of the present invention is to reduce perspiration on the hand of the user, thus improving the grip of the user upon the computer mouse so that the user has greater control of the computer mouse and the corresponding operation on the computer screen.

Another objective of the present invention is to increase the comfort and relaxation of the user by reducing or eliminating the hand perspiration.

A computer mouse with ventilation includes a base having a first air intake inlet, a left side and a right side. The base forms an interior chamber. A cover is mounted on the base. The cover has a first exhaust outlet and an upper surface. A left clicker button and a right clicker button are attached to the base.

A fan is contained within the interior chamber. A motor is attached to the fan with the motor receiving power from the power input device. The power input device supplies electrical power to the motor. The power input device can be a battery contained within the computer mouse or a power cable that receives power from the computer.

An activation switch turns the motor on and off. When the motor is on, the fan draws air through the first air intake inlet and expels air through the first exhaust outlet. The flow of air reduces perspiration on the hand of the user. Reduced perspiration allows the user to firmly grip the computer mouse. Also, the user is more comfortable while operating the computer when there is reduced perspiration. In a variation the computer mouse with ventilation does not have a fan. Lateral movement causes air to flow through the air intake inlet and exit the exhaust outlets.

The first exhaust outlet covers greater than about ten percent of the upper surface. In a variation, the first exhaust outlet covers greater than about fifty percent of the upper surface. The first exhaust outlet can vary in size so that more or less airflow is created upon the hand of the user.

The left clicker button has a second exhaust outlet that receives air from the first air intake inlet. Similarly, the right clicker button has a third exhaust outlet that receives air from the first air intake inlet. A plurality of exhaust apertures are located on the cover between the first exhaust outlet and the clicker buttons. The exhaust apertures are less than about one-fourth the size of the first exhaust outlet.

The computer mouse has a dividing wall contained within the interior chamber. The base, the cover and the dividing wall form a first channel. The first channel receives air from the first air intake inlet and conveys air to the first exhaust outlet. The base has a second air intake inlet and a second channel that also conveys air to the first exhaust outlet. The first air intake inlet is on the left side and the second air intake inlet is on the right side.

Although the present invention is briefly summarized, a fuller understanding of the invention can be obtained from the following drawings, detailed description and appended claims

### BRIEF DESCRIPTION OF THE DRAWINGS

These and other features, aspects and advantages of the present invention will become better understood with reference to the accompanying drawings, wherein:

FIG. 1 is side perspective view.

FIG. 2 is a top view.

FIG. 3 is a top view with the cover removed to show the interior chamber and fan.

### DETAILED DESCRIPTION OF THE PREFERRED EMBODIMENTS

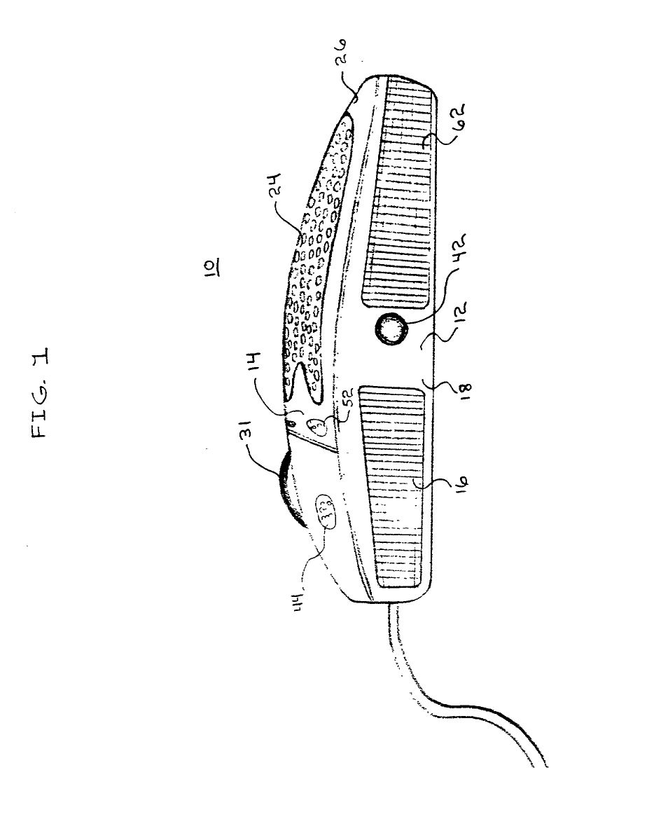

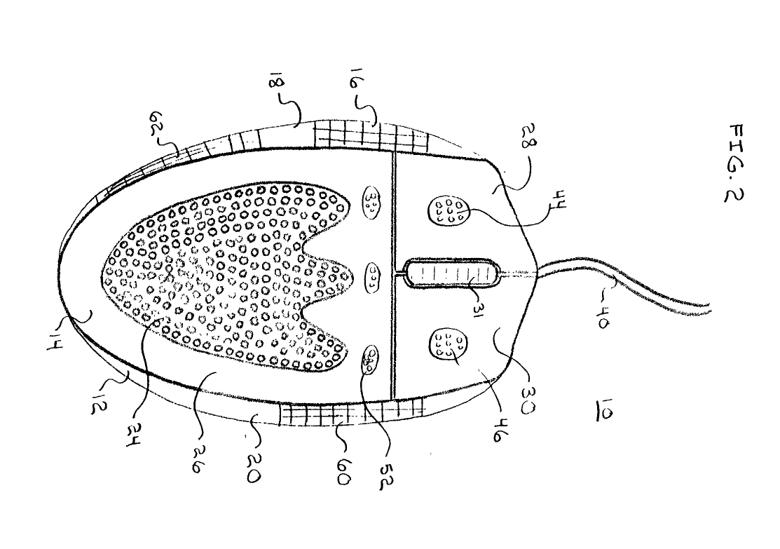

Referring to FIGS. 1, 2, and 3, a computer mouse 10 with ventilation includes a base 12 and a cover 14 mounted on the base 12. The base 12 has a first air intake inlet 16, a left side 18 and a right side 20. The base 12 forms an interior chamber 22. The cover 14 has a first exhaust outlet 24 and an upper surface 26. The left clicker button 28 and the right clicker button 30 are attached to the base 12. A scrolling wheel 31 is positioned between the left clicker button 28 and the right clicker button 30.

A fan 32 is contained within the interior chamber 22. A motor 34 is attached to the fan 32 with the motor 34 receiving power from the power input device. The power input device supplies electrical power to the motor 34. The power input device can be a battery 38 contained within the computer mouse 10 or a power cable 40 that receives power from the computer.

An activation switch 42 turns the motor 34 on and off. When the motor 34 is on, the fan 32 draws air through the first air intake inlet 16 and expels air through the first exhaust outlet 24. The flow of air reduces perspiration on the hand of the user. Reduced perspiration allows the user to firmly grip the computer mouse. Also, the user is more comfortable while operating the computer, when there is reduced perspiration.

The ventilation can be accomplished without the use of a fan 32. The operational movement of the computer mouse 10 causes air to enter the interior chamber 22 through the first exhaust outlet 24. Air residing in the interior chamber 22 is then expelled out through the first exhaust outlet 24 onto the hand. The operational movements of the computer mouse 10 are substantially lateral movements. Lateral movements are most advantageous for prompting air into the first air intake inlet 16. Additionally, a second air intake inlet 60 and third air intake inlet 62 provide increased airflow into the interior chamber 22.

To provide the appropriate ventilation the first exhaust outlet 24 covers greater than about ten percent of the upper surface 26. The first exhaust outlet 24 is illustrated covering greater than about fifty percent of the upper surface 26. The first exhaust outlet 24 can vary in size so that more or less airflow is created upon the hand of the user.

The left clicker button 28 has a second exhaust outlet 44 that receives air from the first air intake inlet 16. Similarly, the right clicker button 30 has a third exhaust outlet 46 that receives air from the first air intake inlet 16. A first conduit 48 transports air from the first air intake inlet 16 to the second exhaust outlet 44. A second conduit 50 transports air from the first air intake inlet 16 to the third exhaust outlet 46.

Alternately, although not shown, the second conduit 50 can be positioned to transport air from the second air intake inlet 60 to the third exhaust outlet 46. The second air intake inlet 60 is positioned on the left side 18, which is closer to the third exhaust outlet 46.

A plurality of exhaust apertures 52 are located on the cover 14 between the first exhaust outlet 24 and the left and right clicker buttons 28, 30. The exhaust apertures 52 are less than about one-fourth the size of the first exhaust outlet 24. The exhaust apertures 52 provide additional ventilation for the fingers of the hand. The fan 32 draws air through the first and second air intake inlets 16, 60. A portion of the air exits through the exhaust apertures 52 as the air passes by the exhaust apertures 52.

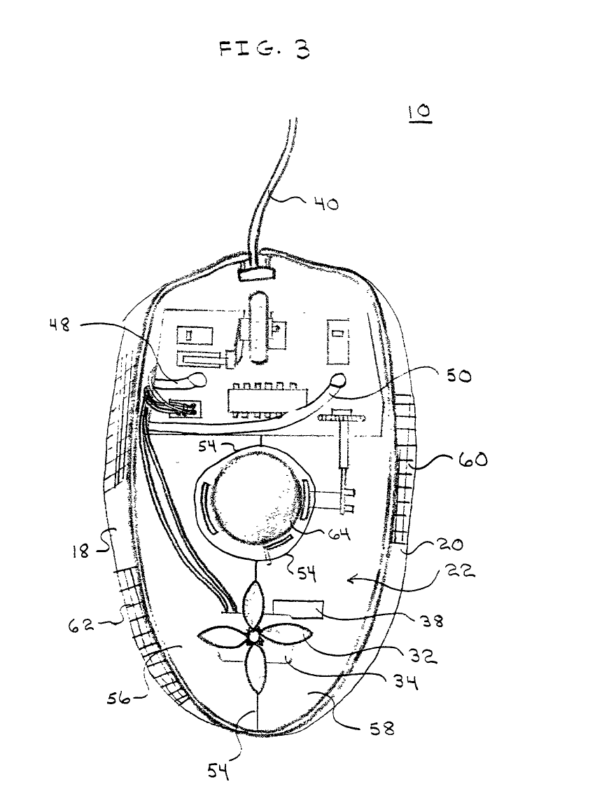

Referring particularly to FIG. 3, the computer mouse has a dividing wall 54 contained within the interior chamber 22. The base 12, the cover 14 and the dividing wall 54 form a first channel 56 and a second channel 58. The first channel 56 receives air from the first air intake inlet 16 and conveys air to the first exhaust outlet 24. The base 12 has the second air intake inlet 60. The second channel 58 receives air from the second air intake inlet 60 and conveys air to the first exhaust outlet 24. The first air intake inlet 16 is on the left side 18 and the second air intake inlet 60 is on the right side 20. A third air intake inlet 62 is located on the left side 18 of the base 12, adjacent to the first air intake inlet 16. Similar to the first air intake inlet 16, the third air intake inlet 62 feeds air into the first channel 48 where the air is propelled by the fan 32 through the first exhaust outlet 24. The exhaust outlet 24 expels air onto the hand of the user, (not shown) which removes perspiration and prevents perspiration from forming on the hand. A dry hand is more comfortable and effective in controlling the computer mouse 10.

Although the present invention has been described in considerable detail with regard to the preferred versions thereof, other versions are possible. Therefore, the appended claims should not be limited to the descriptions of the preferred versions contained herein.

What is claimed is:

1. A computer mouse with ventilation comprising:
a) a base having, a first air intake inlet, a left side and a right side, wherein the base forms an interior chamber;
b) a cover mounted on the base, the cover having a first exhaust outlet and an upper surface;
c) a left clicker button attached to the base; and
d) a right clicker button attached to the base;
wherein when the computer mouse is moved, air enters the first air intake inlet and air exits the first exhaust outlet, thereby reducing perspiration on the hand of the user.

2. The computer mouse of claim 1, wherein the first exhaust outlet covers greater than about ten percent of the upper surface.

3. The computer mouse of claim 2, wherein the first exhaust outlet covers greater than about fifty percent of the upper surface.

4. The computer mouse of claim 3, wherein the left clicker button having a second exhaust outlet, wherein the second exhaust outlet receives air from the first air intake inlet.

5. The computer mouse of claim 4, wherein the right clicker button having a third exhaust outlet, wherein the third exhaust outlet receives air from the first air intake inlet.

6. The computer mouse of claim 3, wherein the cover further having a plurality of exhaust apertures, wherein the exhaust apertures are less than about one-fourth the size of the first exhaust outlet.

7. The computer mouse of claim 6, wherein the computer mouse further comprising a dividing wall contained within the interior chamber, wherein the base, the cover and the dividing wall form a first channel, wherein the first channel receives air from the first air intake inlet and conveys air to the first exhaust outlet.

8. The computer mouse of claim 7, wherein the base further having a second air intake inlet.

9. The computer mouse of claim 8, wherein the first air intake inlet is on the left side and the second air intake inlet is on the right side.

10. A computer mouse with ventilation comprising;
a) a base having a first air intake inlet, a left side and a right side, wherein the base forms an interior chamber;
b) a cover mounted on the base, the cover having a first exhaust outlet and an upper surface;
c) a left clicker button attached to the base;
d) a right clicker button attached to the base;
e) a fan contained within the interior chamber;
f) a motor attached to the fan; and
g) an activation switch, whereby the activation switch can turn the motor on and off;
wherein when the motor is on, the fan draws air through the first air intake inlet and expels air through the first exhaust outlet, thereby reducing perspiration on the hand of the user.

11. The computer mouse of claim 10, further comprising a battery, wherein the battery supplies electrical power to the motor.

12. The computer mouse of claim 10, further comprising a power cable, wherein the power cable supplies electrical power to the motor, whereby the power cable receives power from the computer.

13. The computer mouse of claim 12, wherein the first exhaust outlet covers greater than about ten percent of the upper surface.

14. The computer mouse of claim 13, wherein the first exhaust outlet covers greater than about fifty percent of the upper surface.

15. The computer mouse of claim 14, wherein the left clicker button having a second exhaust outlet, wherein the second exhaust outlet receives air from the first air intake inlet.

16. The computer mouse of claim 15, wherein the right clicker button having a third exhaust outlet, wherein the third exhaust outlet receives air from the first air intake inlet.

17. The computer mouse of claim 16, wherein the cover further having a plurality of exhaust apertures, wherein the exhaust apertures are less than about one-fourth the size of the first exhaust outlet.

18. The computer mouse of claim 17, wherein the computer mouse further comprising a dividing wall contained within the interior chamber, wherein the base, the cover and the dividing wall form a first channel, wherein the first channel receives air from the first air intake inlet and conveys air to the first exhaust outlet.

19. The computer mouse of claim 18, wherein the base further having a second air intake inlet.

20. The computer mouse of claim 19, wherein the first air intake inlet is on the left side, and wherein the second air intake inlet is on the right side.
